(19) United States
(12) Patent Application Publication
(10) Pub. No.: US 2015/0153278 A1
(43) Pub. Date: Jun. 4, 2015

(54) METHOD FOR DETECTING SOILING OF PAPER MACHINE CLOTHING AND PAPER MACHINE CLOTHING

(71) Applicant: VOITH PATENT GMBH, Heidenheim (DE)

(72) Inventors: Marc Erkelenz, Ulm (DE); Franziska Ferrer, Neuburg/Donau (DE); Lisa Nagel, Neu-Ulm (DE)

(73) Assignee: VOITH PATENT GMBH, Heidenheim (DE)

(21) Appl. No.: 14/540,765

(22) Filed: Nov. 13, 2014

Related U.S. Application Data
(63) Continuation of application No. PCT/EP2013/059904, filed on May 14, 2013.

(30) Foreign Application Priority Data
May 16, 2012 (DE) 10 2012 208 201.8

(51) Int. Cl. G01N 21/64; D21F 5/00; G01N 21/94; D21H 21/30

(52) U.S. Cl. CPC G01N 21/64; D21H 21/30; D21F 5/002; G01N 21/94; G01N 2201/061

(57) ABSTRACT

The invention relates to a method for detecting soiling of clothing providing a contact surface and a cavity volume in a machine for producing and/or treating a material web, in particular a fibrous web such as for example, paper, cardboard or tissue web, on which the soiling is detected and evaluated using a detection and evaluation unit. A detection and evaluation unit categorizes the soiling according to the soiling, distinguishing at least between soiling on the contact surface of the clothing and soiling within the clothing.

### CROSS REFERENCE TO RELATED APPLICATIONS

This is a continuation of PCT application No. PCT/EP2013/059904, entitled “METHOD FOR DETECTING SOILING OF PAPER MACHINE CLOTHING AND PAPER MACHINE CLOTHING”, filed May 14, 2013, which is incorporated herein by reference.

### BACKGROUND OF THE INVENTION

1. Field of the Invention

The current invention relates to a method for detecting soiling of paper machine clothing in a machine for the production and/or processing of a material web, in particular a fibrous web.

2. Description of the Related Art

Clothing in web-converting machines is constantly exposed to the influence of soiling which negatively influences its effectiveness.

Paper machines for example employ a multiplicity of clothing for transport and dewatering of a fibrous web that is to be produced. Clothing may be used, for example, in the embodiment of forming fabrics in the forming section, in the embodiment of press felts in the press section, and in the embodiment of dryer fabrics in the dryer section, or in the embodiment of transfer belts. Oftentimes the fabrics and felts are at least partially in the form of woven belts having an open pore structure.

During operation of the paper machine the clothing becomes increasingly soiled by contaminants such as adhesives or other additives which are contained in the fibrous suspension. On a woven fabric for example, the pores and mesh become clogged over a period of time with the aforementioned substances.

Several methods for cleaning clothing in a web converting machine are known from the current state of the art. A method for detecting contaminants according to their chemical and physical characteristics is known from DE10 2005 055 988. In practice this method has proven to be to complex technologically and too ineffective.

What is needed in the art is a method for detecting soiling of clothing wherein improved and simpler detection of the soiling can be accomplished and the detected result utilized for a more effective subsequent cleaning of the soiling from the clothing.

### SUMMARY OF THE INVENTION

The top and bottom side of a clothing providing a contact surface and a cavity volume is detected by a detection and evaluation device, and the detection and evaluation device determines if soiling is present and in the event that soiling is present categorizes the type of soiling into at least one first and one second category, wherein the first category covers soiling of the contact surface and the second category covers soiling of the cavity volume without soiling of the contact surface.

The method according to the invention divides the soiling of the top side and/or bottom side of the clothing into two categories, namely a first category which covers soiling of the contact surface and a second category which covers soiling of the cavity volume without soiling of the contact surface. This allows for very effective assessment of the type of soiling and for its targeted removal in a subsequent cleaning process. The inventors recognized that, for effective cleaning of clothing one must distinguish between outer and interior soiling since clearly different cleaning treatments are necessary for outer and interior soiling. Due to the possibility of being able to distinguish between interior and outer soiling the cleaning can accordingly be optimized effectively and can thereby be optimized achieving time and cost savings. This avoids that certain areas of the clothing are not cleaned sufficiently and that other parts continue to be cleaned, even though they are already clean.

If the soiling is on the contact surface of the clothing then it could be disposed on the material segments of the clothing which are brought into contact during operation of the machine with the fibrous web or with elements of the machine, for example doctor blades, strips, roll covers or similar components. The soiling can possibly connect several of such material segments with each other. In contrast, the interior soiling is disposed in the open cavity volume of the clothing and not on the contact surface of the clothing. It is also conceivable that soiling is disposed on the contact surface and extends into the cavity volume of the clothing, even in one segment. In this case this soiling is allocated to the first category.

The invention makes a distinction between at least two soiling categories, whereby the soiling of both categories—when viewed in thickness direction of the clothing—extend to a different extent into the interior of the clothing and whereby the first category comprises soiling of the contact surface of the clothing, whereas the second category excludes soiling of the contact surface of the clothing.

Where the exact boundary between the two soiling categories is drawn in individual cases depends on a plurality of factors, for example the interior and/or outer structure of the clothing and its cleanability with the cleaning fluid. The exact boundary may be established for example by conducting tests with the respective clothing. It is thereby conceivable that the soiling of the first category includes soiling of the contact surface, as well as soiling which—when viewed in thickness direction of the clothing—extends from the contact surface to 10% into the interior of the clothing relative to the overall thickness of the clothing. The soiling of the second category may be soiling which—when viewed in thickness direction of the clothing—is disposed deeper in the interior than that of the first category. It is however also conceivable that the first category is composed only by soiling of the contact surface of the clothing, whereas the soiling of the second category is composed of all soiling found outside of the contact surface.

If, within the scope of the current invention reference is made to the contact surface, the entire contact surface of the clothing or a part of the contact surface of the clothing may be meant by this.

If, within the scope of the current invention reference is made to the cavity volume, the entire contact cavity volume of the clothing or a part of the cavity volume of the clothing may be meant by this.

The clothing is preferably permeable for fluid, for example water and/or air and/or steam. The clothing may for example be a dryer fabric.

The categorization of the soiling occurs preferably on the basis of a visual inspection of the top and/or bottom side of the clothing. In practice the top and/or bottom side of the clothing is hereby detected by an optical scanner and an assessment and categorization of the soiling is made on the basis of visual contrasts. The top or bottom side of the clothing hereby represents the paper side or the machine side of the clothing. In many instances however, only one of the two sides—top or bottom side—is subjected to the visual inspection.

Another advantageous further development of the method according to the invention provides for treatment of the clothing on the top or bottom side with a liquid cleaning medium by way of a cleaning device for the purpose of removal of the soiling, wherein the cleaning device provides different cleaning programs and the different cleaning programs are selected subject to the categorization of the type of soiling as established by the detection and evaluation unit. Provision is hereby preferably made for the treatment with the cleaning fluid occurs on the same side—that is the top or bottom side of the clothing—as the visual inspection.

In order to adapt the cleaning treatment optimally to local soiling it is provided in particular that locally different regions of one side—that is the top or bottom side—of the clothing are detected chronologically successively and that for each of the detected regions a cleaning program is selected, subject to whether or not soiling is present and into which category the soiling is allocated, and that the cleaning treatment is accomplished in this region with the selected cleaning program. It can herewith also be avoided that clean areas are treated unnecessarily with cleaning fluid. This saves operating costs and increases the service life of the clothing, since the clothing is not for example first cleaned unnecessarily in clean regions, resulting in subsequently having to be dried. Moreover, through local consideration of the type of soiling optimum local cleaning can be accomplished which also saves operating costs. Moreover a very uniform profile in machine direction and cross machine direction can hereby be configured for the clothing characteristics.

Regions which are not soiled are preferably not subjected to cleaning treatment.

The different cleaning programs preferably differ from each other in at least one of the following parameters: impingement angle of the cleaning stream onto the contact surface of the clothing, pressure of the liquid cleaning medium, geometry of the cleaning stream, cleaning duration, cleaning additives, cleaning sequence, duration of the individual cleaning impulses, traversing speed of the cleaning device, drying following the fluid treatment. Through competent selection of one or a combination of several of the aforementioned cleaning parameters in a cleaning program the cleaning treatment can be adapted optimally to the type of soiling.

An additional especially preferred arrangement of the invention provides that a contrast pattern is evaluated for categorization of the soiling, whereby visual contrasts are considered, between material segments providing the contact surface of the clothing which are soiled and such material segments providing the contact surface of the clothing which are not soiled.

This means specifically that in a region with soiled contact surface at least some of the material segments which provide the contact surface of the clothing in this region are soiled. This results in a visually different contrast pattern compared to a region with soiling in the cavity volume of the clothing where the material segments which provide the contact surface of the clothing are not soiled, where however material segments of the clothing in the interior of the clothing are soiled. Trials conducted by the applicant have shown that the soiling on the contact surface of the clothing produces an uneven contrast pattern, whereas in contrast soiling on the interior of the clothing produces a uniform contrast pattern. In clothing in the form of for example a woven fabric the uniform contrast pattern can hereby be established by the distance of the warp and/or weft threads of the weave, depending on whether the contrast pattern is viewed in warp or weft direction. If a visual inspection shows that soiling is present in the region of the contact surfaces as well as in the cavity volume of the inspected region, the inspected region can be reduced to the extent that in said region only one of the two soiling categories remains present. Alternatively it is also conceivable that the size of the inspected region remains the same and a possibly required cleaning treatment is performed with the cleaning program which is allocated to the soiling category which is most strongly represented in terms of area.

For the sake of completeness it should also be noted that, in a non-soiled region of the clothing neither the material segments which form the contact surface, nor the material segments in the interior of the clothing are covered with soiling wherein hereby another contrast pattern is produced compared to the two aforementioned soiling categories.

Specifically, the contrast patterns viewed in machine direction or in cross machine direction can appear as follows:
1) Soiling on the contact surface of the clothing (first category): The sequence of dark-light segments is low-frequency and often uneven according to the extent of the soiling on the contact surface of the clothing, whereby the individual dark segments as a rule are usually more widespread than the dark segments of soiling in the cavity volume.
2) Soiling in the interior of the clothing without soiling of the contact surface (second category): The sequence of dark-light segments is more high frequency and more uniform than in example 1), depending for example on the distance of the yarns in viewing direction.
3) No soiling: only light segments.

To increase the visual contrast an additional arrangement of the method according to the invention provides that the clothing, in particular on the side which is being visually inspected is impinged with an illuminating light, and a response light originating from the clothing in answer to the illuminating light is used for the visual inspection. It should be noted at this point that the term “light” is not used exclusively for electromagnetic radiation in the visible spectral range, but—provided this is not explicitly noted—shall also include electromagnetic radiation in the infrared spectral range (IR-light) and in the ultraviolet spectral range (UV-light).

Various possibilities of impinging the clothing with an illuminating light and design of the response light are conceivable. It is possible that the response light is illuminating light which is at least partially reflected by the clothing, whereby the intensity of the parts of the response light emanating from soiled regions of the clothing differs from the intensity of the parts of the response light emanating from clean regions of the clothing. In this context the illuminating light and the response light can be for example light in the visible spectral range.

To further increase the contrast it is moreover useful if the material of which the clothing is composed includes at least partially luminescent material. If the clothing is composed of a textile structure or a textile fabric with yarns it is especially useful if at least some of the yarns of the clothing include luminescent material. It is thereby possible that the response light emanating from the clothing is at least partially luminescent light in the visual spectral range in response to the illuminating light, whereby the intensity of the part of the response light emanating from the soiled regions of the clothing differs from the intensity of the part of the response light emanating from the clean regions of the clothing. By utilizing the luminescent effect the visual contrast between soiled and clean material segments of the clothing can be further increased. This is especially useful with poor light conditions as prevail inside a dryer section, since a very high contrast can be achieved between clean material segments which “illuminate” due to the luminescence, and soiled material segments where the “illumination” effect is prevented or greatly reduced due to coverage by contaminants.

Preferably at least some of the warp- and/or weft yarns include the luminescent material. It is particularly conceivable that all warp- and/or weft yarns include the luminescent material. It is particularly advantageous if the warp- and/or weft yarns include the luminescent material since hereby also a light/dark pattern which is produced by the “illuminating” and “non-illuminating” yarns and which occurs also with clean clothing and which also makes recognition of the interior soiling more difficult is avoided.

The luminescent material may for example be fluorescent or phosphorescent material.

According to a an arrangement of the inventive method it is conceivable that the illuminating light is UV-light, that the luminescent material is UV-luminescent and that the response light in particular is light within the visible spectral range. According to an alternative arrangement of the inventive method it is moreover conceivable that the illuminating light is IR-light, that the luminescent material is IR-luminescent and that the response light in particular is light in the visual spectral range. In the case of the IR-light the illuminating light may also be heat radiation which is emitted from one or several dryer cylinders in a dryer section of a machine for the production and/or conversion of a material web, in particular a fibrous web, for example a paper, cardboard or tissue web. According to an additional alternative arrangement of the inventive method it is moreover conceivable that the illuminating light and the response light is in the visual spectral range and the yarns of the clothing do not include luminescent material.

According to a another alternative aspect of the invention a machine for the production and/or conversion of a material web, in particular a fibrous web, for example a paper, cardboard or tissue web is suggested which includes a dryer section equipped with one or several IR-light emitting dryer cylinder(s), as well as clothing traveling over the at least one dryer cylinder for at least sectional transportation of the material web through the dryer section, whereby the clothing includes yarns, at least some of which include an IR luminescent material.

According to yet another alternative aspect of the invention clothing for a machine for the production and/or conversion of a material web, in particular a fibrous web, for example a paper, cardboard or tissue web is suggested whereby said clothing includes yarns, at least some of which include a luminescent material.

The clothing may preferably be in the embodiment of a dryer fabric wherein in particular at least some of the warp and\or weft yarns include the luminescent material.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 is a device to implement the inventive method for categorization and cleaning of a clothing,

FIG. 2 is top view of the contaminated clothing shown in FIG. 1,

FIGS. 3A-3C illustrate the contrast pattern of a soiled clothing according to FIG. 2 as detected with the inventive method, and

FIGS. 4A-4D illustrate various enlargements of sections of the clothing in cross direction.

Corresponding reference characters indicate corresponding parts throughout the several views. The exemplification set out herein illustrates an embodiment of the invention, in one form, and such exemplification is not to be construed as limiting the scope of the invention in any manner.

### DETAILED DESCRIPTION OF THE INVENTION

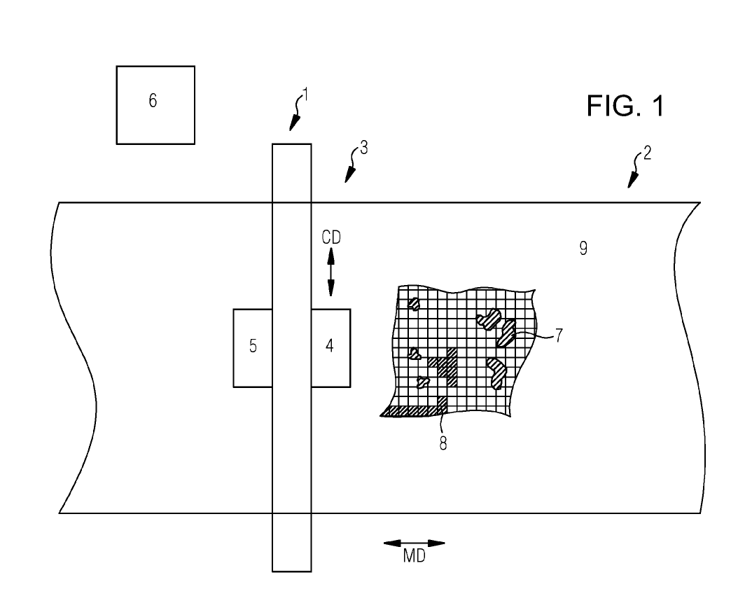

FIG. 1 illustrates an embodiment of a device 1 to implement the method according to the invention for categorization and cleaning of a clothing 2 which is shown only partially in an exemplary schematic depiction in a top view onto top side 9 representing the paper side of clothing 2. In the current example clothing 2 is in the form of a woven fabric comprising warp yarns 10 extending in machine direction MD and weft yarns 11 extending in cross machine direction CD, whereby only a small portion of the yarns are seen in the present illustration.

Device 1 includes a detection and evaluation unit 3 with an optical scanner 4 and an evaluation and control unit 6 communicating with it which in turn communicates with a cleaning device 5.

Optical scanner 4 and cleaning device 5 are arranged on a traversing device and can by means of same traverse in cross machine direction CD transversely to clothing 2. By way of cleaning device 5 topside 9 of clothing 2 can be treated with a liquid cleaning medium for removal of soiling, whereby cleaning device 5 provides different cleaning programs which are selected subject to the categorization of the type of soiling as established by detection and evaluation unit 3. Optical scanner 4 is targeted onto topside 9 of clothing 2 representing the paper side of clothing 2 and in the current example visually detects hereby chronologically successively different local regions of top side 9 of clothing 2 and sends picture signals to the evaluation and control unit 6. Evaluation and control unit 6 evaluates the picture signals captured by optical scanner 4 and on the bases of this automatically controls cleaning device 5. In other words determines with which cleaning program subject to the soiling category of a region the respective region of clothing 2 is treated.

The different cleaning programs differ in at least one of the following parameters from each other: angle of impact of the cleaning stream onto the contact surface of the clothing, pressure of the liquid cleaning medium, cleaning duration, cleaning additives, cleaning sequence, duration of the individual cleaning impulses, traversing speed of cleaning device.

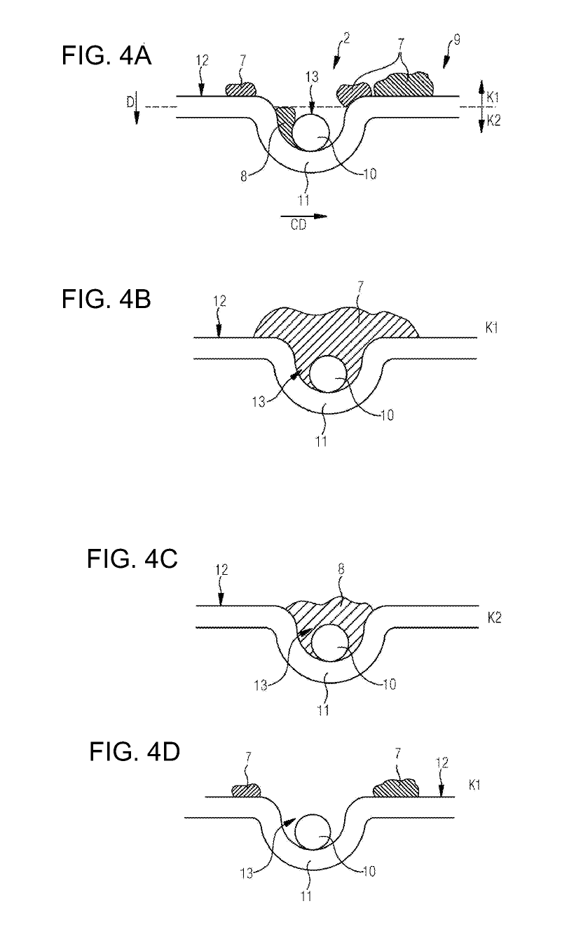

The categorization of the soiling occurs on the basis of a visual inspection of top side 9 of clothing 2. The categorization differentiates according to the invention in all cases between the first category which comprises soiling 7 that is disposed on top of contact surface 12 of clothing 2, and the second category which comprises soiling 8 that is disposed in the cavity volume of clothing 2 and does not cover the contact surface. This can also be seen in FIG. 4 which illustrates enlargements of sections of clothing 2 in CD direction. FIG. 4A depicts soiling 7 of the first category K1 that is disposed on contact surface 12 of top side 9, as well as soiling 8 of the second category that extends in sections in cavity volume 13 and is thereby disposed in thickness direction D of the clothing further in the interior of clothing 2 and does not cover contact surface 12. It must be noted that, in the current example contact surface 12 of clothing 2 is formed by yarn segments of warp yarns 10 and weft yarns 11 of clothing 2 which are brought into contact with a paper web during intended use of clothing 2. In the segment of the clothing as illustrated in FIG. 4, contact surface 12 is formed only by the horizontally progressing segments of weft threads 11.

In FIG. 4B soiling 7 is seen which is disposed on contact surface 12 of top side 9 and which extends into cavity volume 13 of the clothing. Since this soiling covers contact surface 12 it is allocated to first category K1, even though the soiling also extends into cavity volume 13.

In FIG. 4C soiling 7 is seen which is not disposed on contact surface 12 of top side 9, but only in cavity volume 13 of the clothing. This soiling is allocated to second category K2.

In FIG. 4D soiling 7 is seen which is disposed only on contact surface 12 of top side 9. Since this soiling covers contact surface 12 it is allocated to first category K1.

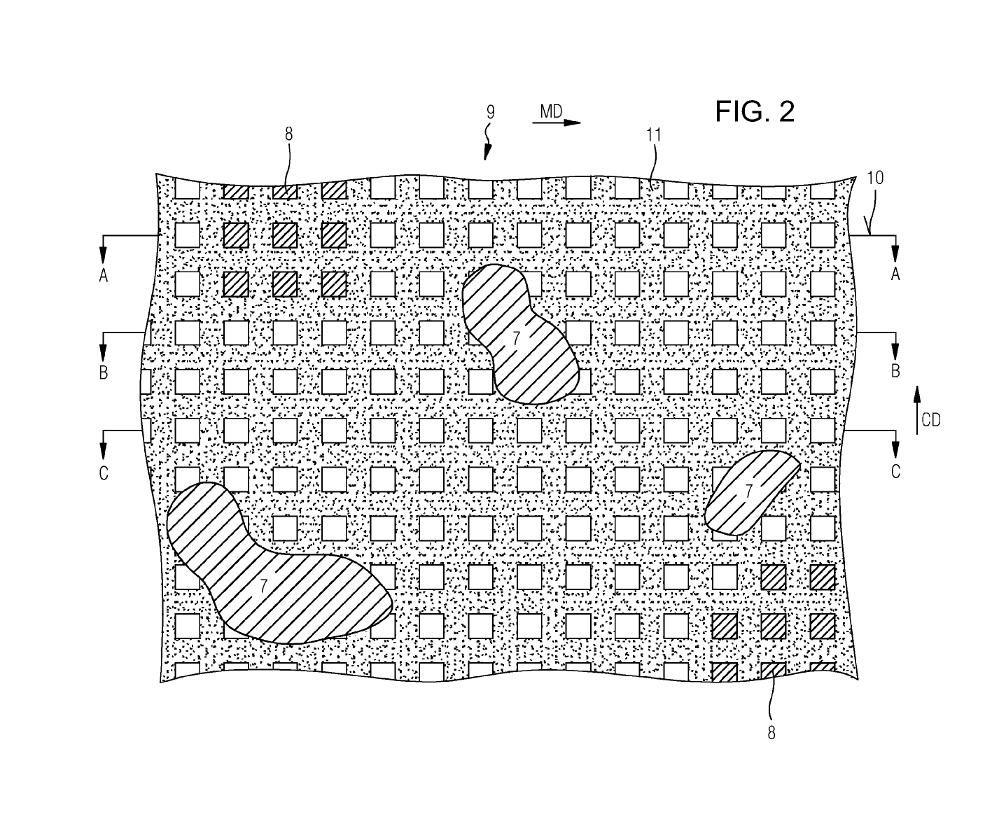

According to an arrangement of the method according to the invention a contrast pattern is evaluated for categorization of the soiling wherein visual contrasts between the yarn segments forming the contact surface and the clothing which are covered with soiling and yarn segments forming the contact surface of the clothing which are not covered with soiling are considered. This is explained in further detail with reference to FIG. 2.

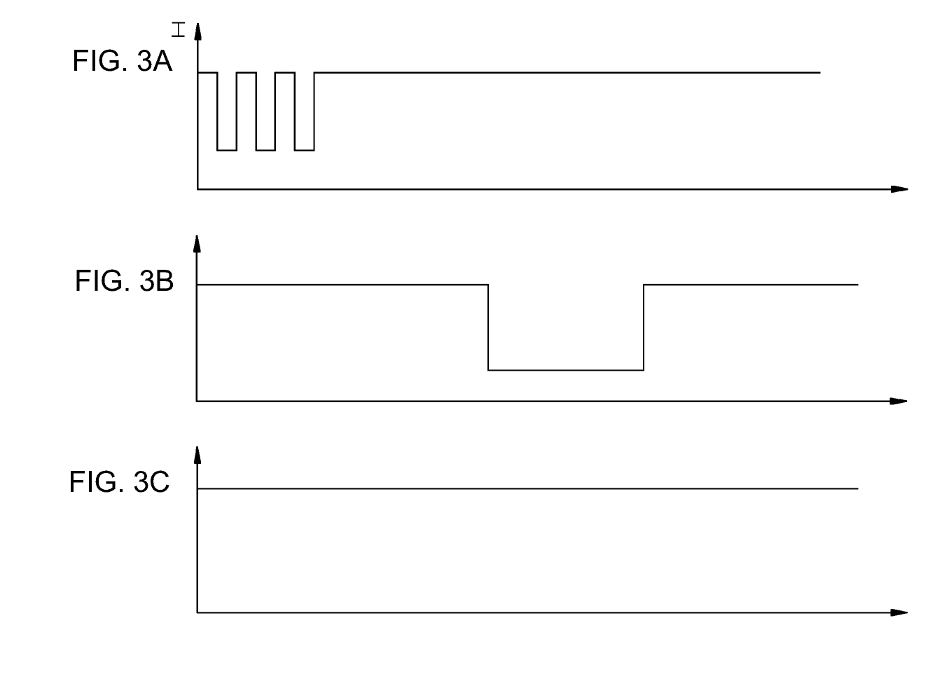

FIGS. 2 and 3 show clothing 2 with different types of soiling (FIG. 2) and the contrast pattern (FIG. 3) resulting therefrom, based on the type of soiling along various scans in machine direction MD. FIG. 3A hereby shows the contrast pattern for the scan along A-A of FIG. 2; FIG. 3B the contrast pattern for the scan along B-B of FIG. 2 and FIG. 3C the contrast pattern for the scan along C-C of FIG. 2. It must also be noted that in the current example warp and weft yarns 10, 11 of clothing 2 include a luminescent material in order to increase the visual contrast.

The scan along A-A shows the region of top side 9 of the clothing with soiling 8 in the interior of clothing 2. This means that the yarn segments which form the contact surface of clothing 2 in this region are not covered with soiling, but that the cavities in the interior of the clothing, as well as possibly yarn segments of the clothing which form the interior of the clothing in this region are covered with soiling. Since the yarns of the clothing include luminescent material the light emanating from them is at least partially luminescent light in answer to an illuminating light sent out for example by an illumination source, whereby the intensity of the parts of the response light emanating from soiled regions of the clothing is less than the intensity of the parts of the response light emanating from clean regions of the clothing. This is reflected in the contrast pattern in FIG. 3A which shows a uniform contrast pattern—respective to the distance of successively arranged weft yarns—along the segment with soiling inside the clothing, and a constant high intensity along the non-soiled segment of the clothing in scan direction A-A.

The scan along B-B shows a region of top side 9 of the clothing with soiling 7 on the contact surface of clothing 2. This means that the yarn segments which provide the contact surface of clothing 2 in this region are soiled. Since the yarns of the clothing include luminescent material the light emanating from them is at least partially luminescent light in answer to an illuminating light sent out for example by an illumination source, whereby the intensity of the parts of the response light emanating from soiled regions of the clothing is less than the intensity of the parts of the response light emanating from clean regions of the clothing. This is reflected in the contrast pattern in FIG. 3B which shows an uneven contrast pattern with a high intensity minimum along the segment with soiling on the contact surface of the clothing, and a constant high intensity along the non-soiled segment of the clothing in scan direction B-B.

The scan along C-C shows a non-soiled region of top side 9 of the clothing. This means that neither yarn segments of clothing 2 which provide the contact surface of the clothing, nor the open cavity volume of the clothing are covered with soiling in this region. Since there is no soiling the contrast pattern in FIG. 3C indicates a uniformly high intensity consistent with the intensity which is generated by non-covered yarn segments of the clothing.

In conclusion it is noted that the illuminating light in the current design example can for example be UV or IR light. The clothing can be laid or knitted fabrics. It is also conceivable that the clothing consists of one or several perforated films.

In conclusion it is pointed out that the terms—“comprise”, “feature”, “include”, “contain” and “with” as well as their grammatical variations used in this description and in the claims to list characteristics are in general to be understood as being a non-comprehensive listing of characteristics, for example of process steps, devices, regions, sizes, etc. and do in no way exclude the presence of other or additional characteristics or groupings of other or additional characteristics.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A method for detecting soiling of paper machine clothing in a machine for at least one of producing and processing of a fibrous material web, wherein the clothing has a top side and a bottom side which provides a contact surface and a cavity volume extending in thickness direction of the clothing from the contact surface into the interior of the clothing, wherein the method comprises the steps of:
detecting soiling on at least one of the top and bottom side using a detection and evaluation device;
determining with the detection and evaluation device if soiling is present; and
categorizing, in the event that soiling is present, the type of soiling into at least one of a first category and a second category, wherein the first category relates to soiling of the contact surface and the second category relates to soiling of the cavity volume without soiling of the contact surface.

2. The method according to claim 1, wherein categorization of the soiling occurs on the basis of a visual inspection of at least one of the top side and bottom side of the clothing.

3. The method according to claim 1, wherein the clothing is treated with a liquid cleaning medium using a cleaning device for the purpose of removal of the soiling, wherein the cleaning device provides different cleaning programs and the different cleaning programs are selected subject to the categorization of the type of soiling as established by the detection and evaluation unit.

4. The method according to claim 3, wherein locally different regions of the top side or bottom side of the clothing are detected chronologically successively and that for each of the detected different regions a cleaning program is selected, subject to the category of the soiling.

5. The method according to claim 4, wherein different cleaning programs differ from each other in at least one of the following parameters: impingement angle of a cleaning stream onto the top side or bottom side of the clothing, pressure of the liquid cleaning medium, cleaning duration, cleaning additives, cleaning sequence, duration of the individual cleaning impulses, traversing speed of the cleaning device.

6. The method according to claim 1, wherein a contrast pattern is evaluated for the categorizing of the soiling, whereby visual contrasts are considered, between material segments providing the contact surface of the clothing which are soiled and such material segments providing the contact surface of the clothing which are not soiled.

7. The method according to claim 6, wherein the soiling on the contact surface of the clothing produces an uneven contrast pattern.

8. The method according to claim 6, wherein the soiling in the cavity volume without soiling of the contact surface of the clothing produces a uniform contact pattern.

9. The method according to claim 6, wherein the visual contrast are increased by impinging the clothing with an illuminating light, and a response light originating from the clothing in response to the illuminating light is used for a visual inspection.

10. The method according to claim 9, wherein the response light receives illuminating light which is at least partially reflected by the clothing, whereby the intensity of the parts of the response light emanating from soiled regions of the clothing differs from an intensity of the parts of the response light emanating from clean regions of the clothing.

11. The method according to claim 9, wherein the clothing is comprised of an at least partially luminescent material, such that at least some of the yarns of the clothing include luminescent material and that the light originating from the clothing is at least partially luminescent light in response to the illumination, whereby the intensity of the part of the response light emanating from the soiled regions of the clothing differs from the intensity of the part of the response light emanating from the clean regions of the clothing.

12. The method according to claim 11, wherein at least a portion of at least one of the warp yarns and weft yarns include the luminescent material.

13. The method according to claim 11, wherein the at least partially luminescent material is fluorescent or phosphorescent material.

14. The method according to claim 11, wherein the illuminating light is UV-light and the at least partially luminescent material is UV-luminescent.

15. The method according to claim 11, wherein the illuminating light is IR-light and that the at least partially luminescent material is IR-luminescent.

16. A clothing for a machine for at least one of producing and converting a fibrous material web, the clothing have a plurality of yarns, at least some of which include a luminescent material.

17. The clothing according to claim 16, wherein the clothing is a dryer fabric.

18. The clothing according to claim 16, wherein the plurality of yarns include a plurality of warp yarns and plurality of weft yarns, and at least a portion of at least one of the warp yarns and weft yarns include the luminescent material.

19. A machine for at least one of producing and treating a fibrous material web, the machine including a dryer section with at least one dryer cylinder emitting IR-light, and clothing routed over the at least one dryer cylinder for at least sectional transportation of the fibrous material web through the dryer section, wherein the clothing includes yarns, at least some of which include IR-luminescent material.
